(19) United States
(12) Patent Application Publication
(10) Pub. No.: US 2014/0379414 A1
(43) Pub. Date: Dec. 25, 2014

(54) CUSTOMER CONFIGURATION DATA COLLECTION

(71) Applicant: Verizon Patent and Licensing Inc., Basking Ridge, NJ (US)

(72) Inventors: Mukesh Kumar, Tampa, FL (US); Krishnakumar N.. Iyer, Cedar Rapids, IA (US); Brian E. Stephenson, Maryville, MO (US)

(21) Appl. No.: 13/926,066

(22) Filed: Jun. 25, 2013

(51) Int. Cl. G06Q 10/06

(52) U.S. Cl. CPC G06Q 10/06316
USPC 705/7.26

(57) ABSTRACT

A method may include receiving a sales order for a customer telecommunications service associated with an enterprise customer. The sales order includes at least one location associated with the enterprise customer. The method includes determining at least one service order based on the customer telecommunications system and each at least one location, and determining a plurality of work orders to implement each of the at least one service order. The method also includes generating a task to collect customer configuration data associated with each of the plurality of work orders and collecting the customer configuration data based on the task to collect the customer configuration data. The method further includes releasing the plurality of work orders and a relationship between the plurality of work orders to a provisioning workflow management device. The provisioning workflow management device is configured to implement provisioning based on the collected customer configuration data.

### BACKGROUND INFORMATION

Telecommunications service providers may receive large and/or complex enterprise orders from enterprise customers (e.g., banks, insurance companies, municipalities, sales organizations, etc.) to provide telecommunications systems, products and/or services. For example, the telecommunications service provider may contract with the enterprise customers to provide services and equipment, such as secure Internet gateway (SIG), Internet protocol, voice over Internet protocol (VoIP), customer premises equipment, etc. Sales quotes for the enterprise orders may include service orders for different locations associated with a customer, such as physical locations and/or virtual locations.

The telecommunications service provider may receive customer configuration data for the contracted services when the enterprise orders are submitted. The configuration data may include domain names, uniform resource locator (URL), Internet protocol (IP) addresses, etc. The service orders may be submitted for work order decomposition, in which service orders are broken down into work orders associated with each service order. For example, work orders may include work orders for implementation of access services, transport services, customer premises equipment (CPE) services, etc., which may be required to fulfill the service order.

Tasks for implementing the sales order are typically implemented at the service order level. Service orders are released as full service orders and not partially released. Changes to sales order typically require entire service orders to be supplemented. Supplementing a service order typically introduces additional complexity associated with managing various versions and statuses for components of the supplemented service orders.

### BRIEF DESCRIPTION OF THE DRAWINGS

FIG. 1 illustrates an exemplary environment in which systems and methods described herein may be implemented;

FIG. 2 illustrates an exemplary work order flow for implementation of a telecommunications system;

FIG. 3 illustrates exemplary components of one or more of the devices included in the environment of FIG. 1;

FIG. 4 is a diagram of an exemplary high level data flow associated with implementation of sales order fulfillment with just in time customer configuration data collection;

FIG. 5 is a diagram of an exemplary user interface for a sales order entry according to an implementation described herein;

FIG. 6 is a diagram of an exemplary user interface for generated work orders including a customer configuration data collection task according to an implementation described herein;

FIG. 7 is a diagram of an exemplary user interface for customer configuration data entry according to an implementation described herein;

FIG. 8 is a diagram of exemplary functional components of the order management system of FIG. 1; and

FIG. 9 is a flowchart of an exemplary process for implementing sales order fulfillment with just in time collection of customer configuration data associated with an enterprise order according to an implementation described herein.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Systems and/or methods described herein may provide collection of customer configuration information at a time that the customer configuration information is to be implemented for enterprise orders (e.g., large complex enterprise orders) using a predetermined architectural design approach in which a sales order is received, service orders are determined based on the sales order, and work orders and a task(s) to collect customer configuration data to fulfill the service orders are generated. Systems and/or methods described herein may allow large and complex enterprise orders to be finalized prior to collection of the customer configuration information, which may not be available at time when the basic information is being collected on the order but may become available at later point of time. The configuration data may be submitted as it becomes available. This “just in time” collection of customer configuration information may include direct storage and consumption of the customer configuration information by targeted provisioning application(s).

Consistent with embodiments described herein, systems and methods may allow the sales order content provided by customers to be lightweight, and allow customers to submit their configuration data themselves (i.e., using a using self-service tool). Systems and/or methods may eliminate data duplication across multiple systems, and simplify business processes and systems leading to better customer due date commitments. For example, an enterprise customer may include multiple divisions that maintain different aspects of a telecommunications system and are responsible for customer configuration information for the different aspects. The responsible individuals in the different divisions may be better able to determine customer due date commitments.

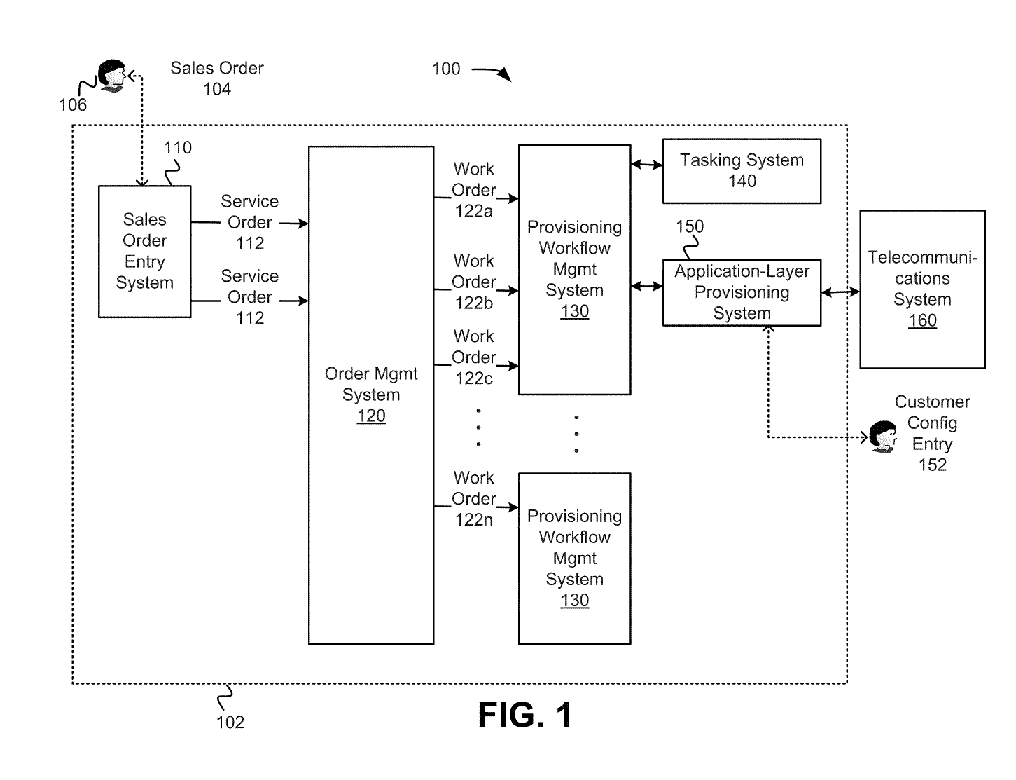

FIG. 1 is a diagram that depicts an exemplary environment in which systems and methods described herein may be implemented. Environment 100 may include a telecommunications services order management system 102 and a customer telecommunications system 160, which may be ordered and provided via telecommunications services order management system 100. Telecommunications services order management system 102 may include a sales order entry system 110, an order management system 120, a plurality of provisioning workflow management systems 130 (shown as provisioning workflow management systems 130-1 to provisioning workflow management systems 130-2), a tasking system 140, and a application-layer provisioning system 150.

The configuration of components of environment 100 illustrated in FIG. 1 is for illustrative purposes. Other configurations may be implemented. Therefore, environment 100 may include additional, fewer and/or different components than those depicted in FIG. 1. Also, in some instances, one or more of the components of environment 100 may perform one or more functions described as being performed by another one or more of the components of environment 100.

Telecommunications services order management system 102 may provide order entry for services associated with implementing customer telecommunications system 160. Customer telecommunications system 160 may be implemented within a network provided by/and or maintained by the telecommunication service provider and may include telecommunications services and/or products, such as intrusion detection systems (IDS), managed network services (MNS), voice over Internet protocol (VoIP), etc. In one example, customer telecommunications system 160 may include a secure Internet gateway that may be deployed across multiple physical and virtual locations.

Sales order entry system 110 may receive new sales orders associated with customer's requesting enrollment in a telecommunications service provided by the telecommunications service provider. New sales orders may be input at a user interface associated with sales order entry system 110, for example, by a sales order entry team 106. Sales order entry system 110 may generate a quote identifier (ID) associated with the sales order. Each sales order may include a list of customer locations and products ordered (e.g., after a contract is finalized). The locations may be physical locations or virtual locations. The sales orders may be divided (e.g., the sales order may be broken down) into service orders 112 per location. The service orders 112 may indicate particular locations where the contracted products and/or services are to be implemented.

Order management system 120 may receive service orders 112 from sales order entry system 110. Order management system 120 may break each service order 112 down into work orders (e.g., work orders 122a to 122n in FIG. 1). Each work order is associated with implementing the products and/or services. For example, to implement (or in the course of implementing) a particular telecommunications service or product (e.g., a secure internet gateway), order management system 120 may break down the particular telecommunication service into component services for the particular telecommunication service (e.g., access services, transport services, CPE services, managed services, etc.). Order management system 120 may determine work orders to implement the component services (e.g., a service order for implementing secure internet gateway may be broken down into an access services work order, a transport services work order, a CPE services work order, a managed services work order, etc.).

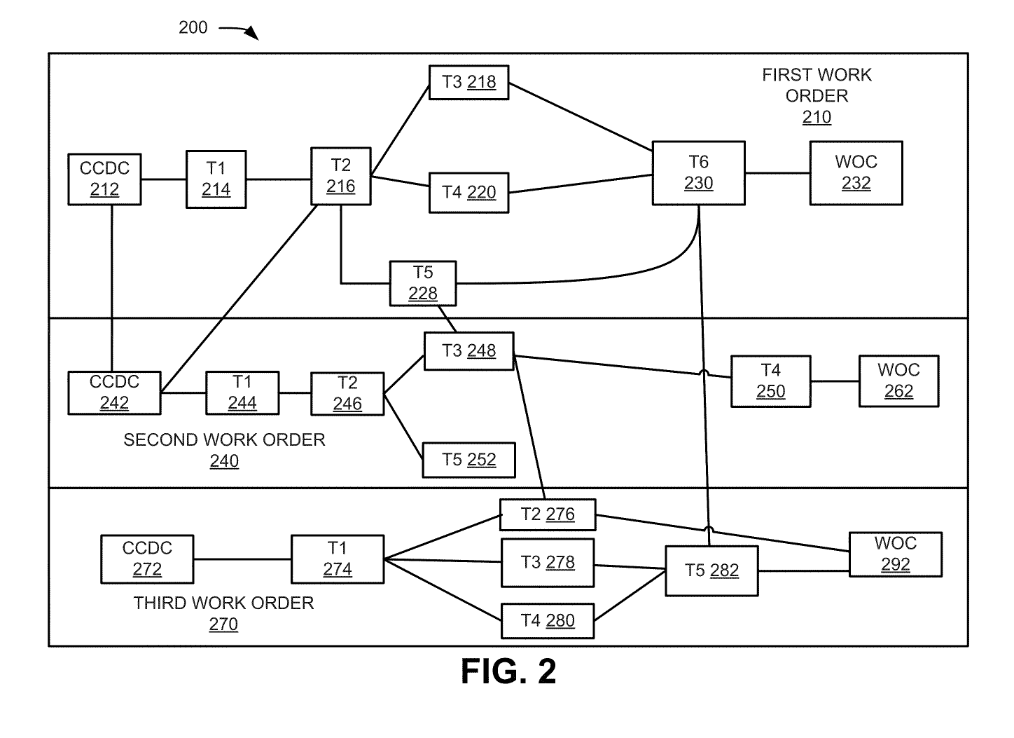

Provisioning workflow management system 130 may receive individual work orders (e.g., work orders 122a, 122b, and 122c in FIG. 1) and associated relationships between the work orders. Provisioning workflow management system 130 may create a provisioning workflow at the work order level, for example as shown in FIG. 2, described below. Provisioning workflow management system 130 may manage interdependencies across work orders for component services (e.g., across an access services work order, a managed services work order and CPE work order). Provisioning workflow management system 130 may manage the provisioning and network configuration associated with a new service order (i.e., work orders that implement the new service order) for a customer. Provisioning workflow management system 130 may initiate the provisioning and network configuration by invoking the operation of application-layer provisioning system 150.

Tasking system 140 may store and distribute work order requests from provisioning workflow management system 130 associated with the configuration of customer telecommunications system 160 to be performed by application-layer provisioning system 150. The work order request may contain information and/or instructions to perform work orders in a provisioning workflow. Tasking system 140 may determine a customer configuration data collection task for collecting customer configuration data collection associated with the requested work orders. A customer configuration entry team 152 (e.g., an engineering team associated with the service provider or the customer) may use the stored work order requests to assist in implementation of the component services (and by extension customer telecommunications system 160).

Customer configuration data for customer telecommunications systems 160 (such as secure Internet gateway, IP, VoIP, IDS etc.) may be available at later time (i.e., not at a same time that provisioning workflow management system 130 is ready to submit the work orders to application-layer provisioning system 150 for provisioning and implementation). Customer configuration data may include service order information, such as, for example, a name of the customer's private IP network, and VPN. Customer configuration data may further include other optional network configuration attributes (e.g., a customer-preferred IP address space, identification of redundant connections for geo-survivability, etc.).

Application-layer provisioning system 150 may configure equipment to implement component services based on provisioning information received from provisioning workflow management system 130 as described with respect to FIG. 2 below. In one implementation, application-layer provisioning system 150 may identify some or all of the customer configuration data that is to be collected as a result of the customer configuration data collection task initiated by tasking system 140.

In implementations described herein, a streamlined lightweight sales order entry and fulfillment architectural design may be implemented with “just in time” collection of customer configuration information for large complex enterprise orders. A lightweight sales order entry may include substantially minimized information that describes telecommunications products and services contracted to be provided by the telecommunications service provider to an enterprise customer. Systems and/or methods described herein may allow large and complex enterprise orders to be finalized prior to collection of customer configuration information. Systems and/or methods may enable the capturing of customer configuration information and then directly storing and consuming the information into targeted provisioning application(s).

FIG. 2 is a diagram of an interdependent work order level provisioning workflow 200. As shown in FIG. 2, interdependent work order level provisioning workflow 200 may include different component work orders, illustrated by way of example as an first work order 210, a second work order 240, and a third work order 270. Interdependent work order level provisioning workflow 200 may be implemented by provisioning workflow management system 130 via instructions provide to application-layer provisioning system 150. Note that first work order 210, second work order 240 and third work order 270 refers to different work orders and not a particular sequence of the work orders.

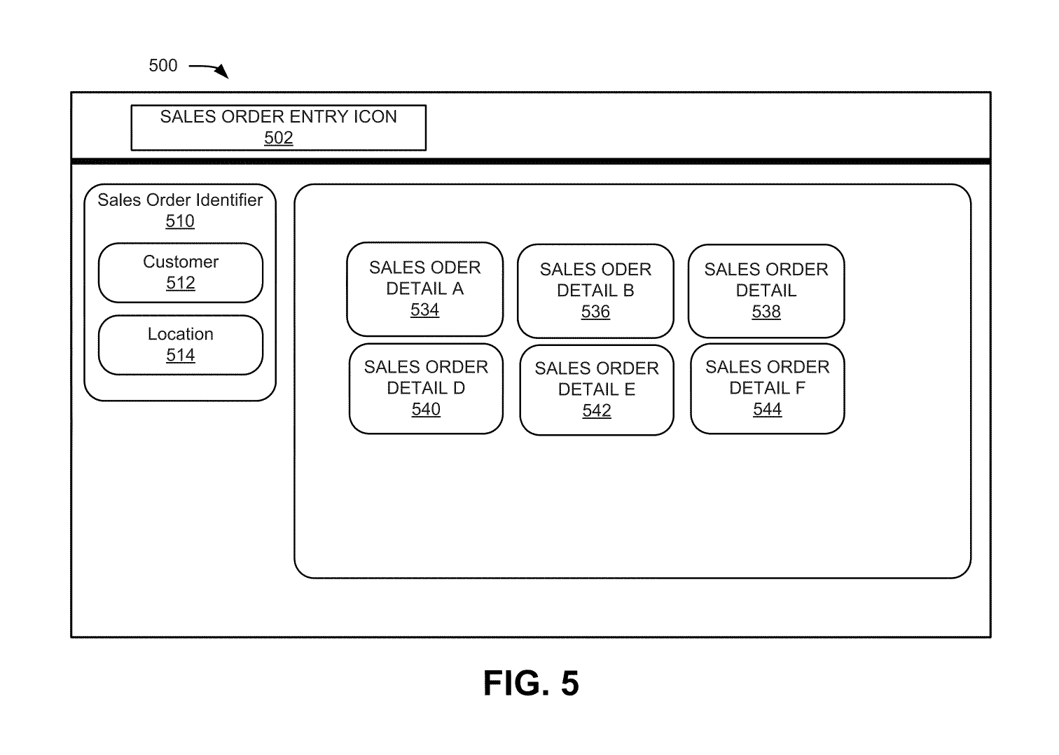

As shown in FIG. 2, each work order (210, 240, 270) may begin with collection (212, 242, 272) and entry of customer configuration data (CCD). The customer configuration data collection (CCDC) may be implemented by the telecommunications service provider or by the customer using a self-service tool, such as described below with respect to FIG. 5, and customer configuration data collection user interface 500.

Application-layer provisioning system 150 may then complete provisioning to implement the component services. For example, while implementing first work order 210, application-layer provisioning system 150 may perform tasks required to implement the work order (in some instances with input from personnel associated with the customer or telecommunications provider) identified by tasking system 140, such as a first task (T1) 214, a second task (T2) 216, a third task (T3) 218, a fourth task (T4) 220, a fifth task (T5) 228, a sixth task (T5) 230 and work order complete (WOC) 232. Application-layer provisioning system 150 may receive automated or manual tasks that are required to implement the work orders.

Similarly, application-layer provisioning system 150 may complete provisioning to implement the other component services. For example, while implementing second work order 240, after customer configuration data collection (CCDC 242), application-layer provisioning system 150 may perform tasks identified by tasking system 140, such as T1 244, T2 246, T3 248, T4 250, T5 252 and WOC 262.

Similarly, while implementing third work order 270, after collecting customer configuration data (CCDC 272), application-layer provisioning system 150 may perform tasks identified by tasking system 140, such as T1 274, T2 276, T3 278, T4 280, T5 282, and WOC 292.

Provisioning workflow management system 130 may manage interdependencies across the workflows for the different work orders (210, 240, 270). For example, provisioning workflow management system 130 may manage workflow across different work orders (e.g., workflow from T6 230 in first work order 210 to T5 282 in third work order 270.

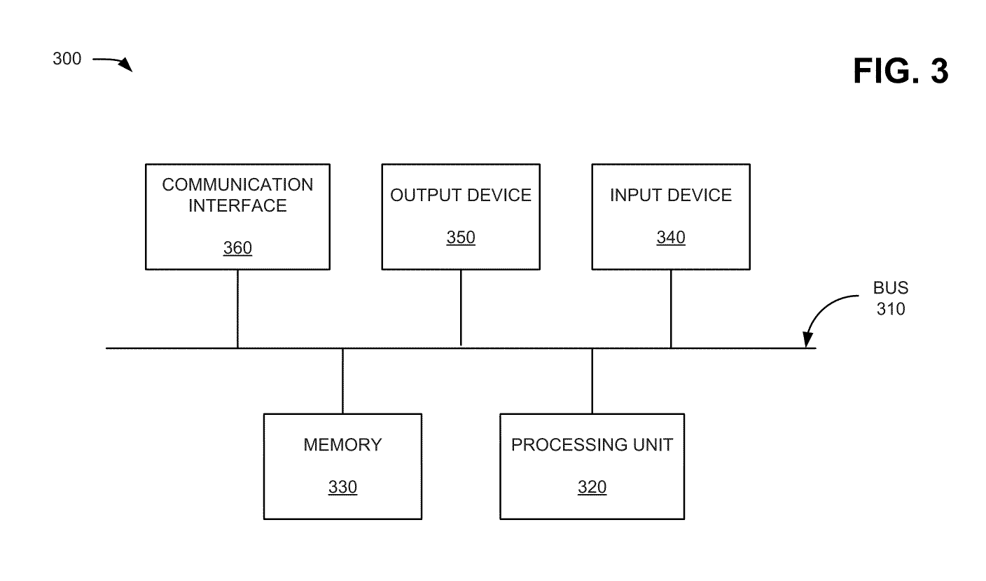

FIG. 3 is a diagram of example components of a device 300. Each of sales order entry system 110, order management system 120, provisioning workflow management systems 130, tasking system 140, application-layer provisioning system 150, may include one or more devices 300. As shown in FIG. 3, device 300 may include a bus 310, a processing unit 320, a memory 330, an input device 340, an output device 350, and a communication interface 360.

Bus 310 may permit communication among the components of device 300. Processing unit 320 may include one or more processors or microprocessors that interpret and execute instructions. In other implementations, processing unit 320 may be implemented as or include one or more application specific integrated circuits (ASICs), field programmable gate arrays (FPGAs), or the like.

Memory 330 may include a random access memory (RAM) or another type of dynamic storage device that stores information and instructions for execution by processing unit 320, a read only memory (ROM) or another type of static storage device that stores static information and instructions for the processing unit 320, and/or some other type of magnetic or optical recording medium and its corresponding drive for storing information and/or instructions.

Input device 340 may include a device that permits an operator to input information to device 300, such as a keyboard, a keypad, a mouse, a pen, a microphone, one or more biometric mechanisms, and the like. Output device 350 may include a device that outputs information to the operator, such as a display, a speaker, etc.

Communication interface 360 may include a transceiver that enables device 300 to communicate with other devices and/or systems. For example, communication interface 360 may include mechanisms for communicating with other devices, such as other devices of system 100.

As described herein, device 300 may perform certain operations in response to processing unit 320 executing software instructions contained in a computer-readable medium, such as memory 330. A computer-readable medium may be defined as a non-transitory memory device. A memory device may include space within a single physical memory device or spread across multiple physical memory devices. The software instructions may be read into memory 330 from another computer-readable medium or from another device via communication interface 360. The software instructions contained in memory 330 may cause processing unit 320 to perform processes described herein. Alternatively, hardwired circuitry may be used in place of or in combination with software instructions to implement processes described herein. Thus, implementations described herein are not limited to any specific combination of hardware circuitry and software.

Although FIG. 3 shows example components of device 300, in other implementations, device 300 may include fewer components, different components, differently arranged components, or additional components than depicted in FIG. 3. Alternatively, or additionally, one or more components of device 300 may perform one or more other tasks described as being performed by one or more other components of device 300.

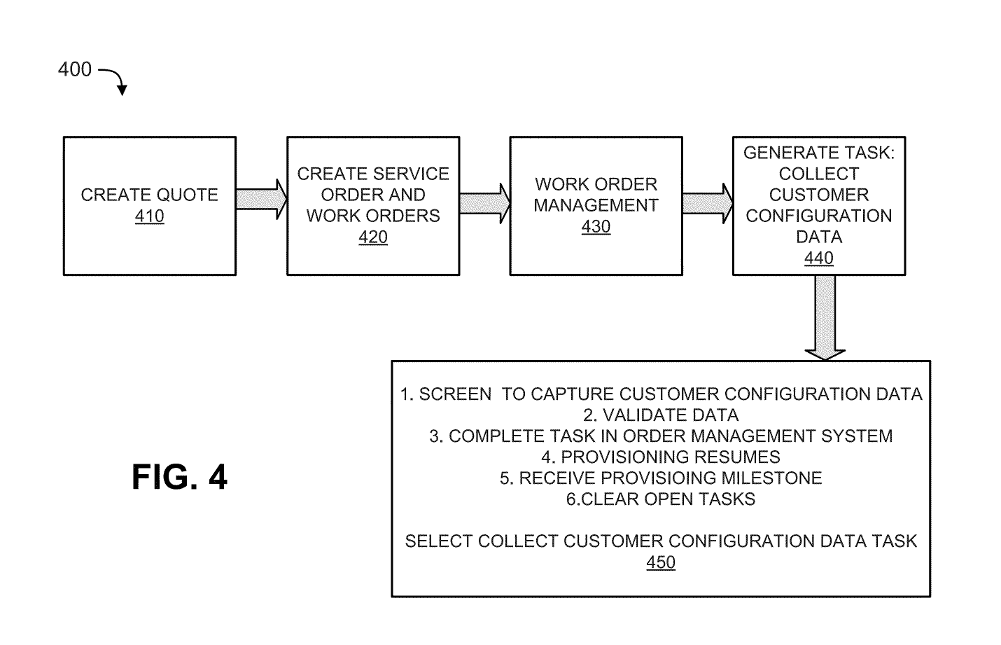

FIG. 4 is a diagram of an exemplary high level sales fulfillment diagram 400. As shown in FIG. 4, high level sales fulfillment diagram 400 may include creating a sales order quote (create quote) 410, creating service orders and work orders (create service orders) 420, managing work orders (work order management) 430 and create task to collect customer configuration data 440.

Create quote 410 may include receiving and entering at sales order system 110, for example by a sales user, a sales order, and assigning a quote ID to the sales order. The quote ID may be generated and used to identify the sales quote offered by the telecommunications service provider to the enterprise customer. The sales user may provide information for sales order system 110 to create a representation of each location and corresponding telecommunications product or service that is included in the sales quote. For example, the sales quote may include an identification or listing of telecommunications products associated with a physical location such as a secure internet gateway for a remote router service associated with a virtual private network (VPN) (e.g., SIG associated with a physical location) and CPE. The sales quote may also include telecommunications products associated with a virtual location such as a secure internet gateway for the virtual location (e.g., SIG-associated with a virtual location). The sales user may input features to sales order system 110 for each product, such as shown in FIG. 5.

Service orders are created (420) based on the sales order. For example, sales order system 110 may generate service orders for products corresponding to each location, such as the SIG associated with the virtual location and SIG associated with the physical location. Sales order system 110 may further generate work orders based on each service order. Personnel associated with the telecommunications service provider (e.g., an order manager) may provide required details for each service order, and submits the service orders to order management system 120.

High level sales fulfillment may include work order management 430 to implement work orders. For example, order management system 120 may break the work orders (i.e., work order decomposition) into subcomponent tasks and provide the work orders to provisioning workflow management system 130. The work orders may be collected in provisioning workflow management system 130. Order management system 120 may release work orders to provisioning workflow management system 130 at work order level (i.e., on an individual work order level). The work orders may contain only order header information at a point of transferal from order management system 120 to provisioning workflow management system 130.

Provisioning workflow management system 130 may send work order collection milestones back to order management system 120. Provisioning workflow management system 130 may receive, collect and send work orders that do not contain customer configuration data to application-layer provisioning system 150.

Order management system 120 may generate a task to collect customer configuration data 440. Alternatively, tasking system 140 may create for the task for “customer configuration data collection” (e.g., the task to collect customer configuration data post provisioning workflow management system 130 work order collection milestone).

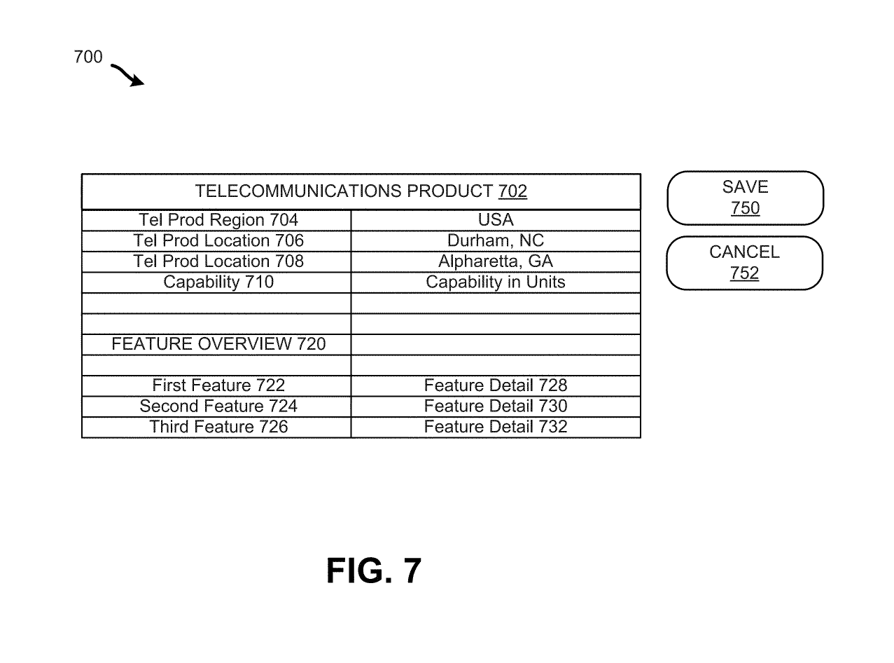

The order manager (or personnel associated with the telecommunications service provider or enterprise customer) may select the generated collect customer configuration data task, as shown in element 450 in FIG. 4. The consuming system (not shown), which may be the end consumer of the customer configuration data. For example, the consuming system that consumes the customer configuration data may be provisioning system for a particular component of the contracted telecommunications system or service. In any regard, the consuming system may launch a customer configuration data collection user interface based upon a user request to input customer configuration data (sub-step 1 of collect customer configuration data task 450), such as described with respect to FIG. 7. The consuming system may validate and store the customer configuration data in the consuming system (sub-step 2 of task 450). Alternatively, the consuming system may update instantiating inventory needed to represent subcomponent systems, devices or products (e.g., particular ports). The work order task may be updated in order management system 120 (sub-step 3 of task 450), for example manually by personnel associated with the telecommunications service provider or by a signal sent from the consuming system to order management system 120. Provisioning of the consuming system may resume (sub-step 4 of task 450). Provisioning workflow management system 130 may notify order management system 120 of next provisioning milestones (sub-step 5 of task 450). Order management system 120 may identify that the previous task has been completed and identify a next task to be completed based on the next provisioning milestones. Order management system 120 may clear any remaining open tasks in tasking system 140 (sub-step 6 of task 450).

According to one implementation, a change may be received in association with the customer telecommunications system 160. The telecommunications service provider may determine whether the change includes changes to the customer configuration data and the service orders. The change may be implemented as a supplement (to the sales order) at the sales order level input at sales order system 110 or as a change to the customer configuration data at the customer configuration data level (i.e., input to the targeted provisioning application). For example, a supplement to the due date (DD sup) may be implemented by order management system 120 in conjunction with tasking system 140. Similarly, order management system 120 may receive a supplement to cancel, which may flow from order management system 120 to provisioning workflow management system 130 to cancel all the provisioning in telecommunications services order management system 100. A supplement to administrative information (e.g., a local contact (LCON) change) may be implemented in a similar manner as a DD supplement without specialized processing required to implement the supplement. Changes to customer configuration data may be implemented at a level of the consuming system (or targeted provisioning application) without supplementing the sales order.

According to another implementation, customer initiated requests (e.g., a change from seven IP addresses to ten IP addresses) that impact price may require a supplement to the provisioning workflow. Tasking system 140 may be assigned an additional task to update the customer configuration data in application-layer provisioning system 150. Change requests after installation of customer telecommunications system 160 is completed, such as adding a remote office site, a mobile user, or changing configuration of a secure Internet gateway port may be implemented in a similar manner as a change order with an additional customer configuration data collection task in instances where required.

FIG. 5 illustrates an exemplary user interface 500 for sales order entry without customer configuration data. Sales order entry interface 500 may provide an ability to receive and enter sales orders from enterprise customers. Sales order entry interface 500 may include a sales order entry icon 502, a sales order identifier 510, customer 512, location 514, and sales order details 534-544 (shown in FIG. 5 as sales order detail A 534, sales order detail B 536, etc.). Although a particular number and arrangement of elements are shown with respect to FIG. 5 and sales order entry interface 500, in practice there may be more, less, or differently arranged elements.

Sales order entry icon 502 may indicate that sales order entries may be input to sales order system 110, for example by sales personnel associated with the telecommunications services provider.

Sales order identifier 510 may indicate a particular sales order, associated with a particular enterprise customer 512. The sales order may be for a particular telecommunications product or system.

Sales order identifier 510 may be associated with a particular location 514 associated with the customer. Location 514 may be a physical location or a virtual location.

The sales user may enter sales order details 534-544. Sales order details 534-544 may include information that describes the service to be provided to the enterprise customer that does not include configuration data. The sales user may enter or receive feedback from sales order system 110 indicating whether changes are price impacting. For example, the sales user may enter information to configure particular product features (e.g., a firewall, a particular telecommunications service, a remote office, etc.). Different products in different locations 514 (e.g., a virtual location and a physical location or two physical locations) may be connected in a same quote. The quote may then undergo pricing and contracting based on input provided to sales order system 110.

The sales order may be entered prior to technical data gathering (including customer configuration data), which may be done at later point of time. The sales order content may be lightweight, in that only price impacting information describing the products and locations that the telecommunications service provider is to provide the enterprise customer. This may lessen chances of failure by reducing an amount of detail required for the initial sales order entry.

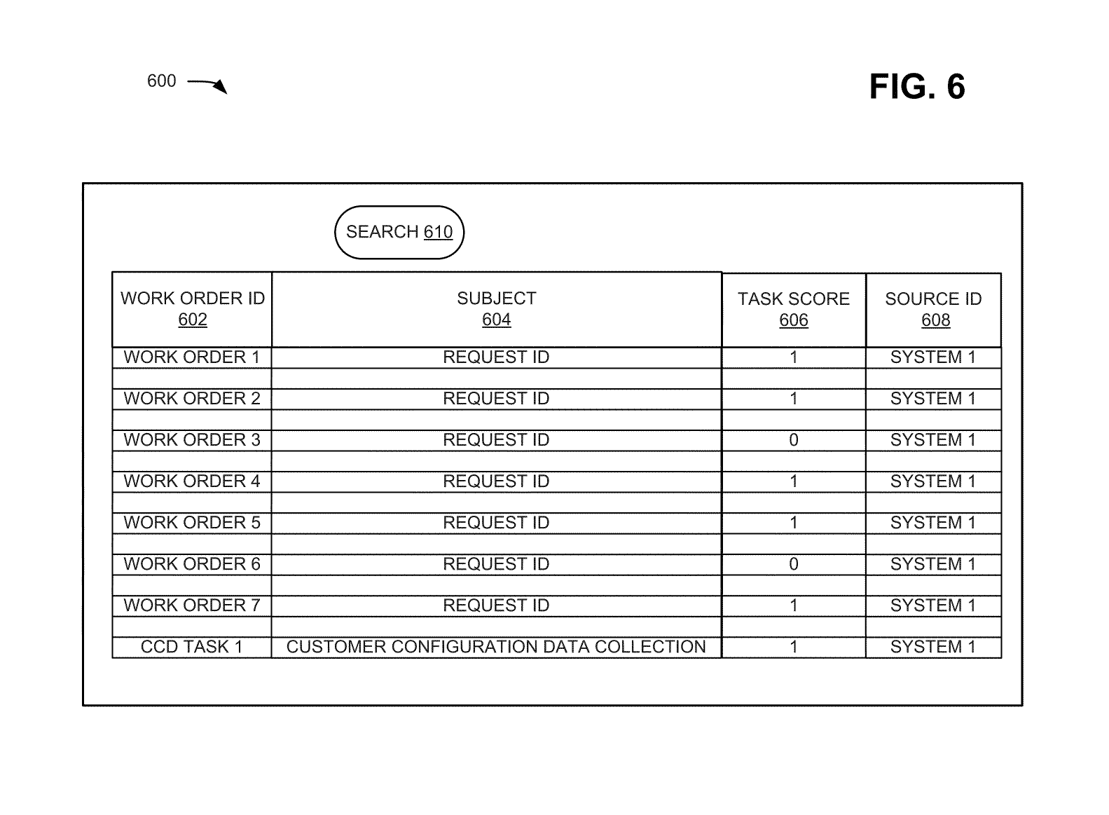

FIG. 6 illustrates an exemplary user interface 600 for providing access to generated work orders. Work order access interface 600 may provide a listing of work order IDs 602 (shown as work order IDs 1-7 and customer configuration data (CCD) collection task. Each work order ID 602 may have an associated subject 604, task score 606, and source ID 608. Although a particular number and arrangement of icons are shown with respect to FIG. 6 and work order access interface 600, in practice there may be more, less, or differently arranged icons.

Work order access interface 600 may provide the ability to access work orders (identified by work order IDs 602) that are generated from service orders. Work order access interface 600 may be provided in association with tasking system 140.

Subject 604 may describe aspects of each particular work order, such as a type of work order (e.g., an access work order, etc.). Task score 606 may define whether a work order task has been completed (e.g., a task score of 1 may indicate that the work order task has been completed, a task score of 0 may indicate that the task has not been completed). Source ID 608 may identify a system in which the work order is to be implemented (e.g., customer telecommunications system 160).

Work order access interface 600 may provide the ability to search 610 for work orders associated with a particular sales order and a customer configuration data collection task. For example, personnel associated with the telecommunication service provider may be authenticated (e.g., using a password, etc.) and may input information associated with a particular service order or sales order and receive search results associated with the service order or sales order.

FIG. 7 illustrates an exemplary user interface 700 for facilitating entry of customer configuration data. Customer configuration data entry interface 700 is shown for a particular customer configuration data consuming system at which the customer configuration data may be entered, such as a telecommunications product 702. Although a particular number and arrangement of elements are shown with respect to FIG. 7 and customer configuration data entry interface 700, in practice there may be more, less, or differently arranged icons.

Customer configuration data entry interface 700 represents a user interface associated with consuming system (not shown), which may be the end consumer of the customer configuration data. Each consuming system that is a direct consumer of customer configuration data may have an associated customer configuration data entry interface 700. Customer configuration data entry interface 700 may be implemented as part of a system associated with the telecommunications service provider or as a user interface for a self-service tool that may be provided for the relevant personnel associated with the enterprise customer to input customer configuration data.

In any event, customer configuration data entry personnel may select a particular work order when the customer configuration data is available for entry. Customer configuration data entry personnel may include personnel associated the telecommunications service provider or personnel associated with the enterprise customer. Customer configuration data entry interface 700 may be displayed (e.g., for telecommunications product 702) to capture the customer configuration data. Telecommunications product 702 may be any telecommunications product, system, or service or combination of products, systems, or services provided by the service provider to the enterprise customer (e.g., a firewall, a secure Internet gateway, managed services, etc.)

As shown, customer configuration data for telecommunications product 702 may include a telecommunications product region 704 (indicated as USA), a telecommunications product primary location 706 (indicated as Durham, N.C.), a telecommunications product backup location 708 (indicated as Alpharetta, Ga.), a capability 710 associated with the telecommunications product (e.g., bandwidth, etc.), which may be listed in appropriate units, and feature overviews 720 for different features 722-726 of the telecommunications product (e.g. first aspect 722, second aspect 724, third aspect 726 may include a remote and retail office, a mobile user, a firewall, etc.).

Feature details 728-732 associated with the features 722-726 may include information that describes configuration for each particular feature, such as a number of groups, a number of concurrent users a type of telecommunications product, a number of IP addresses required, a and other specifications that describe customer configuration data for the telecommunications product 702.

The user may save or cancel changes to customer configuration data by selecting one of save 750 or cancel 752.

The consuming system may validate the customer configuration data and store the customer configuration data in an associated memory storage device.

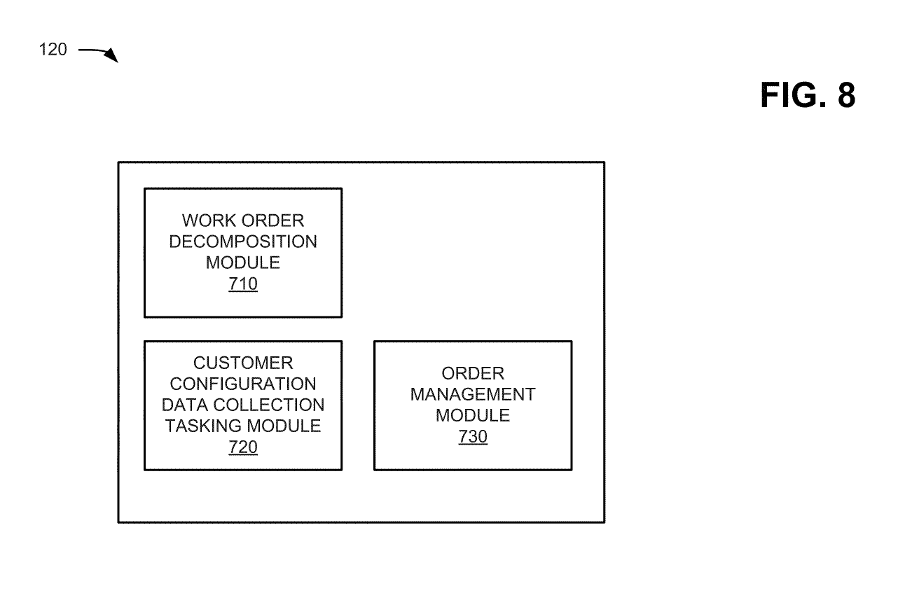

FIG. 8 is a diagram of exemplary functional components of order management system 120. In one implementation, the functions described in connection with FIG. 8 may be performed by one or more components of device 300 (FIG. 3). As shown in FIG. 8, order management system 120 may include a work order decomposition module 710, a customer configuration data collection tasking module 720, and an order management module 730.

Work order decomposition module 710 may break down work orders into tasks required to implement the work orders. For example, work order decomposition module 710 may break an access work order into subcomponent tasks, similarly as described above with respect to access work order 219 shown in FIG. 2.

Customer configuration data collection tasking module 720 may create a task to collect customer configuration data. For example, customer configuration data collection tasking module 720 may create a task to collect customer configuration data for each consuming system associated with a work order for a particular service (e.g., access, managed services, etc.) that is required to implement a telecommunications system 160. Customer configuration data collection tasking module 720 may enable simplification of business process and systems flow, by allowing customer configuration data collection at any time (starting with during quoting phase).

Order management module 730 may manage tasks to implement work orders. For example, order management module 730 may send work orders to provisioning workflow management system 130 and assign and clear tasks in tasking system 140 while implementing work orders.

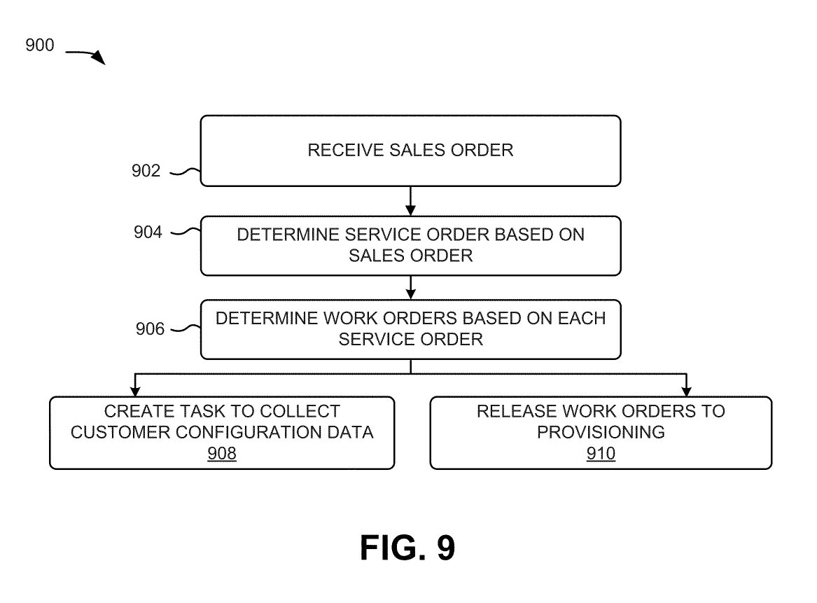

FIG. 9 is a flow chart of an exemplary process for implementing sales order fulfillment with just in time collection of customer configuration data associated with an enterprise order according to implementations described herein. In one implementation, process 900 may be performed by telecommunications services order management system 100. In another implementation, some or all of process 900 may be performed by another device or group of devices, including or excluding telecommunications services order management system 100.

At block 902, telecommunications services order management system 100 may generate a sales order to provide a telecommunications system 160 to an enterprise customer. Telecommunication system 160 may include a large-scale telecommunications product or service that requires customer configuration data associated with the enterprise customer in order to be implemented. The sales order may be received and finalized without receipt of some or all of the customer configuration data that may be required to actually provision or implement the ordered products or services.

At block 904, telecommunications services order management system 100 may create a service order for each location associated with the sales order.

At block 906, telecommunications services order management system 100 may create work orders based on each service order to implement the service order.

Telecommunications services order management system 100 may create a task to collect customer configuration data associated with the work orders (block 908). The customer configuration data may be entered by the enterprise customer via a self-service portal associated with either the customer or the services/products being provisioned. Telecommunications services order management system 100 may avoid data duplication across various systems. Telecommunications services order management system 100 may directly enter the customer configuration data into targeted applications that are actual consumer of the data (e.g., an application programming interface (API) from a task management system to a targeted application that includes a user interface to enter technical data for a particular product, such as SIG).

Telecommunications services order management system 100 may release the work orders to provisioning workflow management system 130 (block 910), which may manage provisioning of the work orders (provisioning workflow) when the customer configuration data is received. Telecommunications services order management system 100 may release the work orders before, after or concurrently with creating the task to collect the customer configuration data in block 908.

Telecommunications services order management system 100 may continue provisioning after the customer configuration data is collected, for instance, based on a provisioning workflow.

Systems and methods described herein may provide collection of customer configuration information at a time that the customer configuration information is to be implemented for enterprise orders (e.g., large complex enterprise orders) using a predetermined architectural design approach in which a sales order is received, service orders are determined based on the sales order, and work orders and a task to collect customer configuration data to fulfill the service orders are generated.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. For example, while series of blocks have been described with respect to FIG. 9, the order of the blocks may be modified in other implementations. Further, non-dependent blocks may be performed in parallel.

It will be apparent that different aspects of the description provided above may be implemented in many different forms of machine-readable instructions, firmware, and hardware in the implementations illustrated in the figures. The actual machine-readable instructions or specialized control hardware used to implement these aspects is not limiting of the invention. Thus, the operation and behavior of these aspects were described without reference to the specific machine-readable instructions—it being understood that machine-readable instructions and control hardware can be designed to implement these aspects based on the description herein.

Further, certain portions of the invention may be implemented as a “component” or “system” that performs one or more functions. These components/systems may include hardware, such as a processor, an ASIC, or a FPGA, or a combination of hardware and machine-readable instructions.

No element, act, or instruction used in the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

What is claimed is:

1. A computer-implemented method comprising:
receiving a sales order for a customer telecommunications service associated with an enterprise customer, wherein the sales order includes at least one location associated with the enterprise customer;
determining, by a computing device, at least one service order based on the customer telecommunications system and each at least one location;
determining a plurality of work orders to implement each of the at least one service order;
generating a task to collect customer configuration data associated with each of the plurality of work orders;
collecting the customer configuration data based on the task to collect the customer configuration data; and
releasing the plurality of work orders and a relationship between the plurality of work orders to a provisioning workflow management device, wherein the provisioning workflow management device is configured to implement provisioning based on the collected customer configuration data.

2. The computer-implemented method of claim 1, wherein receiving the sales order further comprises:
receiving a lightweight sales order that initially does not contain customer configuration data for the customer telecommunications service.

3. The computer-implemented method of claim 1, wherein the customer telecommunications service is at least one of a secure Internet gateway, managed services, voice over Internet protocol or an intrusion detection system.

4. The computer-implemented method of claim 1, wherein the at least one location comprise multiple locations and at least one of the multiple locations is a physical location and at least one of the multiple locations is a virtual location.

5. The computer-implemented method of claim 1, wherein collecting the customer configuration data further comprises:
receiving, from a device associated with customer configuration data entry personnel, a selection of the task to collect the customer configuration data;
generating a user interface to capture the customer configuration data, wherein the user interface is associated with an application-layer provisioning system;
validating the customer configuration data;
storing the customer configuration data in association with the application-layer provisioning system;
indicating that the task is complete; and
continuing provisioning associated with the work order based on the customer configuration data.

6. The computer-implemented method of claim 5, further comprising:
receiving a notification of a next provisioning milestone from provisioning workflow management device; and
identifying a next task to be completed based on the next provisioning milestone.

7. The computer-implemented method of claim 1, wherein the telecommunications service is a secure Internet gateway and receiving the sales order further comprises:
receiving an indication of features associated with the secure Internet gateway including at least one of a firewall, a mobile user, and a remote office.

8. The computer-implemented method of claim 1, further comprises:
receiving a change to the customer telecommunications service;
determining whether the change includes changes to the customer configuration data and the service orders;
implementing a supplement at the service order level if the change includes a change to the service orders.

9. The computer-implemented method of claim 8, further comprising:
implementing a change to the customer configuration data at an application-layer provisioning system if the change includes only a change to the customer configuration data.

10. The computer-implemented method of claim 1, wherein determining the plurality of work orders to implement the each the at least one service order further comprises:
determining the plurality of work orders to implement one or more of managed services, customer premises equipment services, transport services or access services.

11. The computer-implemented method of claim 1, further comprising:
creating a provisioning flow at a work order level; and
managing interdependencies across the plurality of work orders.

12. A device, comprising:
a memory to store a plurality of instructions; and
a processor configured to execute the instructions in the memory to:
receive a sales order for a customer telecommunications system associated with an enterprise customer, wherein the sales order includes at least one location associated with the enterprise customer;
determine, by a computing device, at least one service order based on the customer telecommunications system and each of the at least one location;
determine a plurality of work orders to implement each of the at least one service order;
generate a task to collect customer configuration data associated with each of the plurality of work orders;
collect the customer configuration data based on the task to collect the customer configuration data; and
release the plurality of work orders to a provisioning workflow management device, wherein the provisioning workflow management device is configured to implement provisioning based on the collected customer configuration data.

13. The device of claim 12, wherein, when receiving the sales order, the processor is further configured to:
receive a lightweight sales order that initially does not contain customer configuration data for the customer telecommunications service.

14. The device of claim 12, wherein the customer telecommunications service is at least one of a secure Internet gateway, managed services, voice over Internet protocol or an intrusion detection system.

15. The device of claim 12, wherein the at least one location comprise multiple locations and at least one of the multiple locations is a physical location and at least one of the multiple locations is a virtual location.

17. The device of claim 12, wherein the processor is further to:
receive, from a device associated with customer configuration data entry personnel, a selection of the task to collect the customer configuration data;
generate a user interface to capture the customer configuration data, wherein the user interface is associated with an application-layer provisioning system;
validate the customer configuration data;
store the customer configuration data in association with the application-layer provisioning system;
indicate that the task is complete; and
continue provisioning associated with the work order based on the customer configuration data.

18. The device of claim 12, wherein the processor is further to:
receive a change to the customer telecommunications service;
determine whether the change includes changes to the customer configuration data or the service orders;
implement a supplemental at the service order level if the change includes a change to the service orders.

19. A system, comprising:
a sales order system configured to
receive a sales order for a customer telecommunications service associated with an enterprise customer, wherein the sales order includes at least one location associated with the enterprise customer,
determine, by a computing device, at least one service order based on the customer telecommunications system and each of the at least one location, and
determine at least one work order to implement each of the at least one service order;
an order management system configured to
decompose each of the plurality of work orders into subcomponent tasks, and
generate a task to collect customer configuration data associated with each of the plurality of work orders;
collect the customer configuration data based on the task to collect the customer configuration data; and
a provisioning workflow management device configured to implement provisioning based on the collected customer configuration data.

20. The system of claim 19, further comprising:
A customer configuration data consuming system configured to:
receive, from a device associated with customer configuration data entry personnel, a selection of the task to collect the customer configuration data;
generate a user interface to capture the customer configuration data, wherein the user interface is associated with a targeted provisioning application;
validate the customer configuration data;
store the customer configuration data in association with the targeted provisioning application;
indicate to the order management system that the task is complete; and
continue provisioning associated with the work order based on the customer configuration data and input received from the provisioning workflow management device.
